(19) United States
(12) Patent Application Publication
(10) Pub. No.: US 2018/0175333 A1
(43) Pub. Date: Jun. 21, 2018

(54) BATTERY, BATTERY CAN, BATTERY PACK, ELECTRONIC DEVICE, ELECTRIC VEHICLE, POWER STORAGE DEVICE, AND POWER SYSTEM

(71) Applicant: Sony Corporation, Tokyo (JP)

(72) Inventors: Kunio SODEYAMA, Fukushima (JP); Takao MORI, Fukushima (JP); Masafumi UMEKAWA, Fukushima (JP); Kazunori NOGUCHI, Fukushima (JP)

(21) Appl. No.: 15/573,357

(22) PCT Filed: May 18, 2016
(86) PCT No.: PCT/JP2016/002434

§ 371 Date: Nov. 10, 2017

(30) Foreign Application Priority Data
Jun. 16, 2015 (JP) 2015-121396

(51) Int. Cl. H01M 2/02; H01M 2/12; H01M 2/34; H01M 4/525; H01M 10/052; H01M 10/42; H02J 7/00

(52) U.S. Cl. CPC H01M 2/024; H01M 2/022; H01M 2/1235; H01M 2/345; H01M 2004/028; H01M 10/052; H01M 10/425; H02J 7/0068; H01M 4/525

(57) ABSTRACT

A battery includes: an electrode body; and a battery can configured to accommodate the electrode body and include a bottom part. At least one surface of the bottom part has two or more grooves on a same circumference, a proportion of an inner diameter of the groove to an outer diameter of the bottom part is 44% or more, and a proportion of a total value of intervals of the grooves to a perimeter of the circumference is 2% or more and 24% or less.

### TECHNICAL FIELD

The present technology relates to a battery, a battery can, a battery pack, an electronic device, an electric vehicle, a power storage device, and a power system in which an electrode body is housed in a battery can.

### BACKGROUND ART

In recent years, lithium ion secondary batteries have been used in most electronic devices. In a lithium ion secondary battery, for example, when abnormal heat is applied in an overcharged state, gas pressure abnormally increases on a can bottom side (bottom side), which may cause battery rupture. Particularly, in lithium-ion secondary batteries of high capacity and high power, an amount of gas generated when abnormal heat is applied is large, and a center hole of an electrode body has a small diameter, and thus gas escaping to a sealing part side (a top side) of the battery is decreased, and gas pressure on the can bottom side is likely to be abnormally high.

In order to prevent the rupture of a battery mentioned above, a battery in which a groove is formed in a can bottom of a battery can, the groove part is broken when abnormal heat is applied to the battery, and generated gas is discharged from the can bottom has been proposed (for example, see Patent Literatures 1 to 3).

Patent Literature 1 discloses a battery in which one non-annular groove is formed in a bottom part of a metallic battery can. Patent Literature 2 discloses a battery in which one or more cut-open parts are formed on a bottom surface of a metallic case in an arc shape along a peripheral wall, and a cross section is formed in a “V”-shaped groove form. Patent Literature 3 discloses a battery in which rupture pressure of a thin wall part of a bottom part of a battery case caused by gas pressure is higher than rupture pressure of a valve body of an explosion-proof sealing plate and lower than withstanding pressure of a sealing part of the battery.

### CITATION LIST

### Patent Literature

Patent Literature 1: JP H10-092397A

Patent Literature 2: JP S60-155172A

Patent Literature 3: JP H6-333548A

### DISCLOSURE OF INVENTION

### Technical Problem

However, in the battery in which the groove is formed in the can bottom as described above, when the abnormal heat is added to the battery, the battery may rupture with no proper cleavage of the groove, and the electrode body may come out of the battery can due to the cleavage of the groove of the can bottom. Further, when the battery is dropped, the electrode body may come out of the battery can due to the cleavage of the groove of the can bottom.

It is an object of the present technology to provide a battery, battery can, a battery pack, an electronic device, an electric vehicle, a power storage device, and a power system which is capable of improving safety when abnormal heat is applied while suppressing a decrease in mechanical strength of the bottom part of the battery can.

### Solution to Problem

A first technology to achieve the above object is a battery, including: an electrode body; and a battery can configured to accommodate the electrode body and include a bottom part. At least one surface of the bottom part has two or more grooves on a same circumference, a proportion of an inner diameter of the groove to an outer diameter of the bottom part is 44% or more, and a proportion of a total value of intervals of the grooves in a circumferential direction of the circle to a perimeter of the circle is 2% or more and 24% or less.

A second technology is a battery pack, including: the battery; and a control unit configured to control the battery.

A third technology is an electronic device, including: the battery. The electronic device is supplied with electric power from the battery.

A fourth technology is an electric vehicle, including: the battery; a conversion device configured to be supplied with electric power from the battery and convert the electric power into driving power for the vehicle; and a control device configured to perform information processing related to vehicle control on the basis of information related to the battery.

A fifth technology is a power storage device, including: the battery. The power storage device supplies electric power to an electronic device connected to the battery.

A sixth technology is a power system, including: the battery. The power system is supplied with electric power from the battery.

A seventh technology is a battery can, including: a bottom part of which at least one surface has two or more grooves on a same circumference. A proportion of an inner diameter of the groove to an outer diameter of the bottom part is 44% or more, and a proportion of a total value of intervals of the grooves in a circumferential direction of the circle to a perimeter of the circle is 2% or more and 24% or less.

### Advantageous Effects of Invention

As described above, according to the present technology, it is possible to improve safety when abnormal heat is applied while suppressing a decrease in mechanical strength of the bottom part of the battery can.

### BRIEF DESCRIPTION OF DRAWINGS

FIG. 1 is a cross-sectional view illustrating a configuration example of a non-aqueous electrolyte secondary battery according to a first embodiment of the present technology.

FIG. 2A is a plane view illustrating an example of a can bottom including two or more grooves. FIG. 2B is a cross-sectional view taken along line IIB-IIB of FIG. 2A.

FIG. 3A is a plane view illustrating an example of a can bottom including two grooves of the same length. FIG. 3B is a plane view illustrating an example of a can bottom including three grooves of the same length.

FIG. 4A is a plane view illustrating an example of a can bottom including four grooves of the same length. FIG. 4B is a plane view illustrating an example of a can bottom including five grooves of the same length.

FIG. 5A is a plane view illustrating an example of a can bottom including grooves of different lengths. FIG. 5B is a plane view illustrating an example of a can bottom including different groove intervals.

FIG. 6 is a schematic diagram for describing the flow of heat when abnormal heat is applied to a battery.

FIG. 7A is a plane view illustrating an example of a can bottom including an annular groove. FIG. 7B is a plane view illustrating an example of a can bottom including a “C”-shaped groove.

FIG. 8 is a cross-sectional view illustrating an enlarged part of a wound electrode body shown in FIG. 1.

FIG. 9 is a schematic diagram for describing the flow of gas generated when abnormal heat is applied to a battery.

FIG. 10A is a cross-sectional view illustrating a configuration example of a can bottom of a non-aqueous electrolyte secondary battery according to a first modified example of a first embodiment of the present technology. FIG. 10B is a cross-sectional view illustrating a configuration example of a can bottom of a non-aqueous electrolyte secondary battery according to a second modified example of the first embodiment of the present technology.

FIG. 11 is a block diagram illustrating a configuration example of a battery pack and an electronic device according to a second embodiment of the present technology.

FIG. 12 is a schematic diagram illustrating a configuration example of a power storage system according to a third embodiment of the present technology.

FIG. 13 is a schematic diagram illustrating a configuration of an electric vehicle according to a fourth embodiment of the present technology.

FIG. 14A is a graph illustrating a relation between a proportion Ra of an inner diameter Rᵢₙ of a groove to an outer diameter Rₒᵤₜ of a can bottom and a test pass rate. FIG. 14B is a graph illustrating a relation between a proportion Rb of a total value D of intervals of a groove to a perimeter L of a circumference and a test pass rate.

FIG. 15A is a graph illustrating a relation between a thickness t of a can bottom in a groove bottom and a test pass rate. FIG. 15B is a graph illustrating a relation between a width w of a groove and a test pass rate.

### MODE(S) FOR CARRYING OUT THE INVENTION

Embodiments of the present technology will be described in the following order.

1. First embodiment (example of cylindrical battery)
2. Second embodiment (examples of battery pack and electronic device)
3. Third embodiment (example of power storage system)
4. Fourth embodiment (example of electric vehicle)

### 1. Second Embodiment

### [Configuration of Battery]

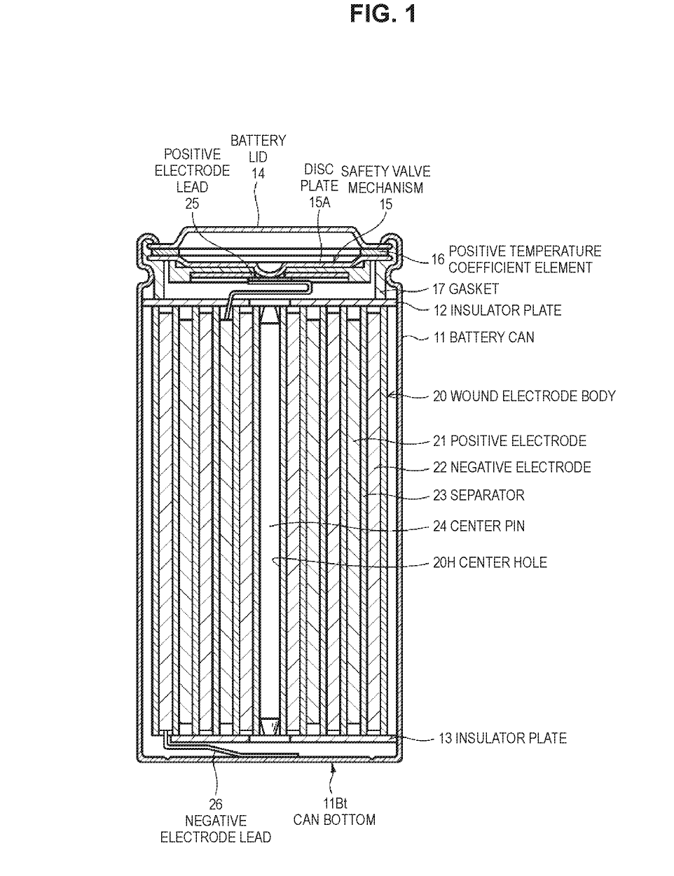

Hereinafter, a configuration example of a non-aqueous electrolyte secondary battery (hereinafter, it may be referred to simply as “battery”) according to a first embodiment of the present technology will be described with reference to FIG. 1. The non-aqueous electrolyte secondary battery is a so-called lithium ion secondary battery, for example, for which the capacity of its negative electrode is represented by a capacity component based on intercalation and deintercalation of lithium (Li) which is an electrode reaction substance. The non-aqueous electrolyte secondary battery is of a so-called cylinder type and has, inside a battery can 11 which is hollow and substantially columnar, a wound electrode body 20 obtained by winding a pair of a belt-shaped positive electrode 21 and a belt-shaped negative electrode 22 which are layered to interpose a separator 23. The battery can 11 is configured of iron (Fe) plated with nickel (Ni), one end part thereof is closed and the other end part is opened. The electrolyte solution is injected into the battery can 11 as an electrolyte, and is impregnated into the positive electrode 21, the negative electrode 22 and the separator 23. Moreover, a pair of insulator plates 12 and 13 are disposed perpendicular to the circumferential surface of winding to interpose the wound electrode body 20. In the following description, of both end parts of the battery, a closed end part side of the battery can 11 is also referred to as a “bottom side,” and an opposite side, that is, an opened end part side of the battery can 11 is also referred to as a “top side.”

To the opening end part of the battery can 11, a battery lid 14, a safety valve mechanism 15 provided in the battery lid 14, and a positive temperature coefficient (PTC) element 16 are attached by swaging via an opening sealing gasket 17. Thereby, the inside of the battery can 11 is sealed. The battery lid 14 is configured, for example, of a material similar to that of the battery can 11. In a case in which gas is generated in the battery can 11 at the time of abnormality, the safety valve mechanism 15 is cleaved and discharges the gas from the top side of the battery. Further, the safety valve mechanism 15 is electrically connected to the battery lid 14 and on the occasion that the inner pressure of the battery is not less than a certain value due to internal short, heating from the outside or the like, a disc plate 15A is configured to reverse so as to cut the electric connection between the battery lid 14 and the wound electrode body 20. The opening sealing gasket 17 is configured, for example, of insulative material and its surface is applied with asphalt.

The wound electrode body 20 has a substantially cylindrical shape. The wound electrode body 20 includes a center hole 20H penetrating from a center of one end surface to a center of the other end surface. A center pin 24 is inserted into the center hole 20H. The center pin 24 has a tubular shape in which both ends are opened. Therefore, the center pin 24 functions as a flow path for guiding gas from the bottom side to the top side in a case in which gas is generated in the battery can 11.

A positive electrode lead 25 made of aluminum (Al) or the like is connected to a positive electrode 21 of the wound electrode body 20, and a negative electrode lead 26 made of nickel or the like is connected to a negative electrode 22. The positive electrode lead 25 is welded to the safety valve mechanism 15 to be electrically connected to the battery lid 14, and the negative electrode lead 26 is welded to the battery can 11 to be electrically connected thereto.

In the non-aqueous electrolyte secondary battery according to the first embodiment, an open circuit voltage (that is, a battery voltage) in a completely charged state for each pair of the positive electrode 21 and the negative electrode 22 may be 4.2 V or less, or may be designed to be within a range that is higher than 4.2 V, preferably 4.4 V or more and 6.0 V or less, and more preferably 4.4 V or more and 5.0 V or less. It is possible to obtain high energy density by increasing the battery voltage.

Hereinafter, the battery can 11, the positive electrode 21, the negative electrode 22, the separator 23, and the electrolyte solution of the non-aqueous electrolyte secondary battery will be sequentially described below.

(Battery can)

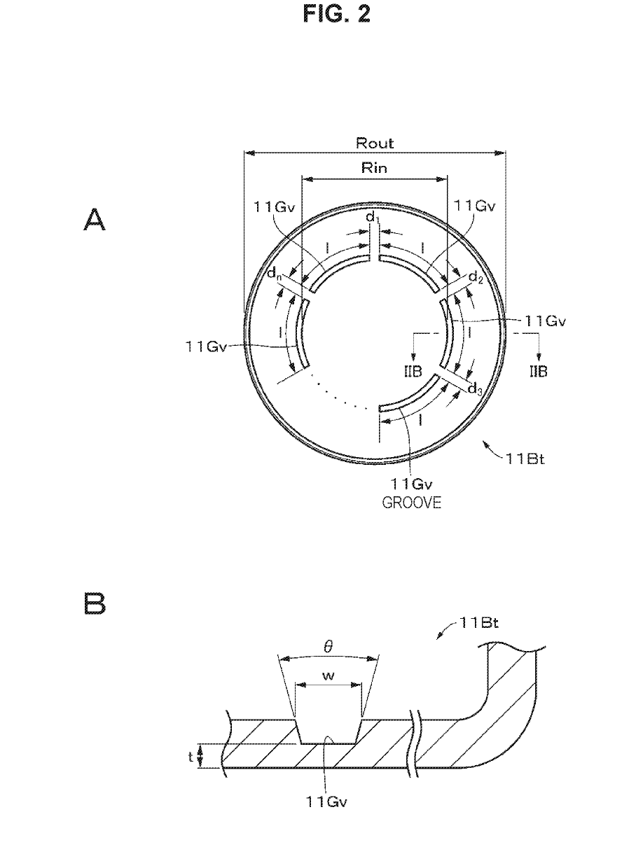

The battery can 11 includes a can bottom 11Bt serving as a bottom part on a side of one end part which is closed. If the can bottom 11Bt is viewed in the vertical direction, the can bottom 11Bt has a circular shape as illustrated in FIG. 2A. Of the can bottom 11Bt, a surface serving as an inside of the battery can 11 (hereinafter referred to simply as an “inside surface of the can bottom 11Bt”) has two or more grooves 11Gv on the same circumference as illustrated in FIGS. 2A and 2B. This circle is concentric with an outer shape of the can bottom 11Bt.

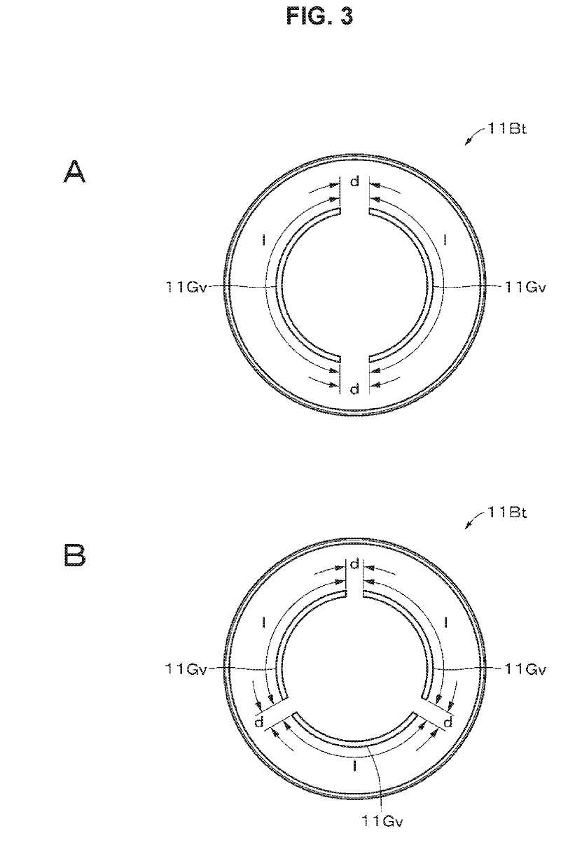

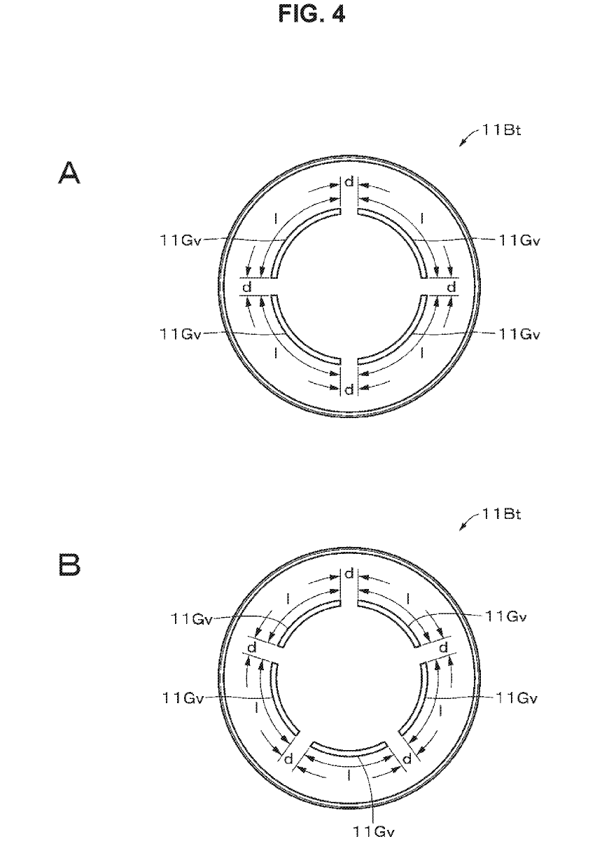

The groove 11Gv has an arc shape. The number of the grooves 11Gv is not particularly limited as long as it is two or more, but the number of the grooves 11Gv is 2 to 5, for example, as illustrated in FIGS. 3A, 3B, 4A, and 4B (hereinafter referred to as “FIG. 3A and the like”).

As illustrated in FIG. 3A and the like, lengths 1 of the grooves 11Gv in the circumferential direction may be equal, and intervals d between the grooves 11Gv in the circumferential direction may be equal. In other words, two or more grooves 11Gv may have rotational symmetry with respect to the center of the can bottom 11Bt. Here, “intervals between the grooves 11Gv in the circumferential direction” means intervals between the grooves 11Gv measured along the circumference on which the grooves 11Gv are formed.

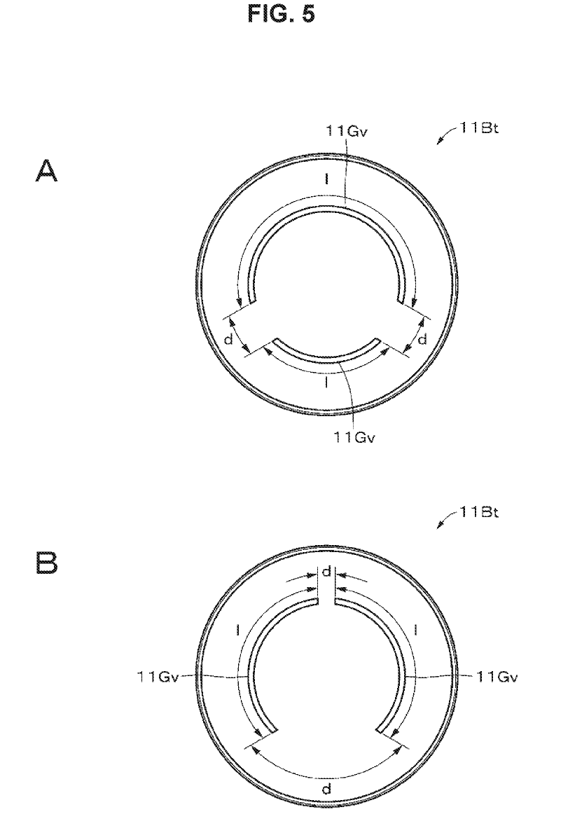

(a) The lengths 1 of the grooves 11Gv in the circumferential direction may be different, and the intervals d between the grooves 11Gv in the circumferential direction may be equal as illustrated in FIG. 5A, (b) the lengths 1 of the grooves 11Gv in the circumferential direction may be equal, and the intervals d between the grooves 11Gv in the circumferential direction may be different as illustrated in FIG. 5B, or (c) the lengths 1 of the grooves 11Gv in the circumferential direction may be different, and the intervals d between the grooves 11Gv in the circumferential direction may be different as illustrated in FIG. 5A. In a case in which any of the above-described configurations (a) to (c) is employed, the two or more grooves 11Gv may have non-rotational symmetry with respect to the center of the can bottom 11Bt.

The proportion Ra (=(Rᵢₙ/Rₒᵤₜ)×100) of the inner diameter (diameter) Rᵢₙ of the groove 11Gv to the outer diameter (diameter) Rₒᵤₜ of the can bottom 11Bt is 44% or more. Further, the proportion Rb (=(D/L)×100) of a total length D of the intervals d of the grooves 11Gv in the circumferential direction with respect to a perimeter L of a circumference on which the grooves 11Gv are formed is 2% or more and 24% or less.

Here, “perimeter L of the circumference on which the grooves 11Gv are formed” means the perimeter of the inner diameter of the groove 11Gv and is obtained, specifically, by L=πRᵢₙ. Further, as illustrated in FIG. 2A, in a case in which n (n is an integer of 2 or more) grooves 11Gv are formed on the same circumference, the “total length D of the intervals d of the grooves 11Gv in the circumferential direction” is obtained by D=d₁+d₂+ . . . +dₙ.

If the proportion Ra is less than 44%, the battery may rupture when abnormal heat is applied to the battery. If the proportion Rb exceeds 24%, the battery may rupture when abnormal heat is applied to the battery. On the other hand, if the proportion Rb is less than 2%, the wound electrode body 20 may come out of the battery can 11 when abnormal heat is applied to the battery. Further, if the proportion Rb is less than 2%, and the proportion Ra is 88% or more, the wound electrode body 20 may come out of the battery can 11 when the battery is dropped.

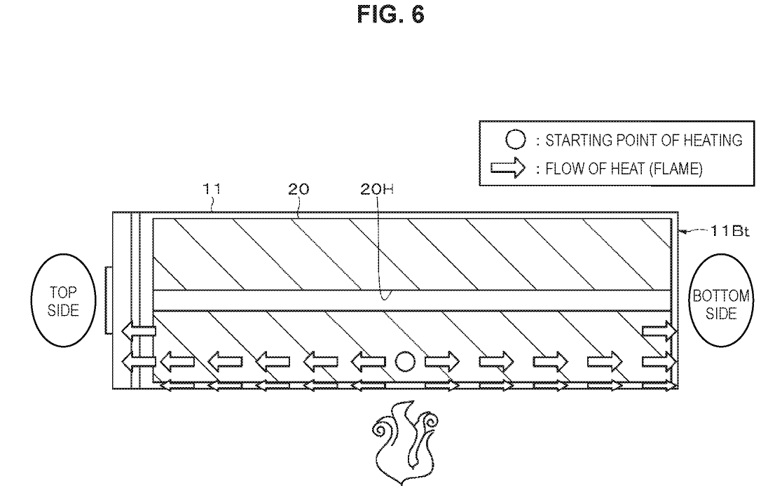

Here, the reason for setting the proportion Ra to be 44% or more will be more specifically described with reference to FIG. 6. If abnormal heat is applied to the battery from the outside, heat (flame) is generated from the outer circumference part of the wound electrode body 20. The heat (flame) has a function of softening the groove 11Gv of the can bottom 11Bt, and the groove 11Gv closer to the outer circumference part of the wound electrode body 20 is more likely to be softened. If the proportion Ra is 44% or more, since the groove 11Gv is close to the outer circumference part of the wound electrode body 20, the groove 11Gv of the can bottom 11Bt is likely to be softened when abnormal heat is applied to the battery from the outside. Therefore, when the gas pressure of the can bottom 11Bt is increased by the generated gas, it is possible to cleave the groove 11Gv of the can bottom 11Bt and allow the gas to escape to the outside. On the other hand, if the proportion Ra is less than 44%, since the groove 11Gv is far from the outer circumference part of the wound electrode body 20, it is difficult for heat generated during a burning test to soften the groove 11Gv. Therefore, even though the gas pressure of the can bottom 11Bt is increased by the generated gas, the can bottom 11Bt may not be cleaved and is unable to allow the gas to escape to the outside.

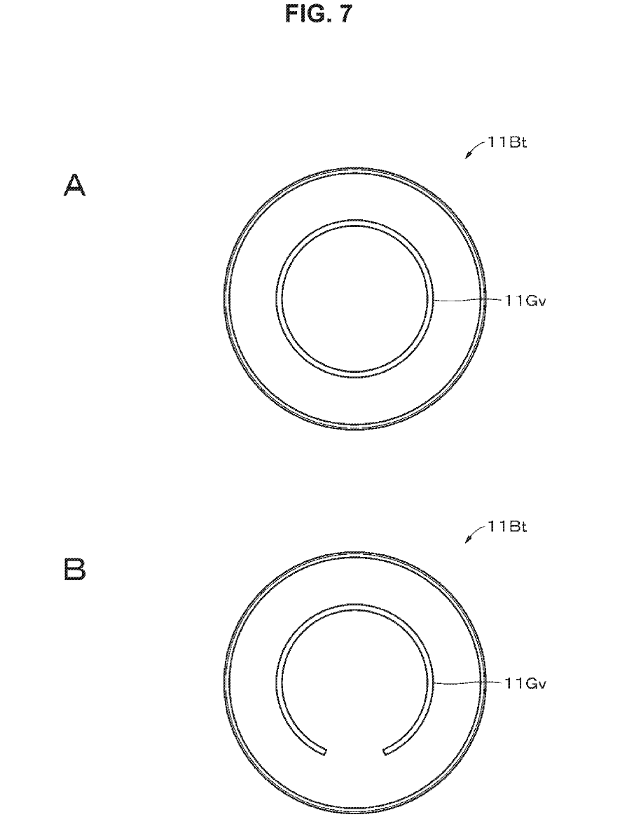

If the number of the grooves 11Gv is less than 2, the safety is lowered. Specifically, in a case in which the number of grooves 11Gv is one, and the groove 11Gv has an annular shape having no intermittent part as illustrated in FIG. 7A, the cleavage strength of the groove 11Gv is low, and thus when the abnormal heat is applied to the battery or when the battery is dropped, the wound electrode body 20 may come out of the battery can 11. In a case in which the number of grooves 11Gv is one, and the groove 11Gv has a shape in which a part of an annular shape is omitted (that is, a “C” shape or an inverted “C” shape) as illustrated in FIG. 7B, and thus in order to set the proportion Rb to be 2% or more and 24% or less, it is necessary to set the length of the groove 11Gv in the circumferential direction to be half or more of the length of the circumference. However, if this length is set, as in the case in which the groove 11Gv is annular, the cleavage strength of the groove 11Gv is decreased, and when the abnormal heat is applied to the battery or when the battery is dropped, the wound electrode body 20 may come out of the battery can 11.

A thickness t of the can bottom 11Bt in the bottom of the groove 11Gv is preferably 0.020 mm or more and 0.150 mm or less. If the thickness t is less than 0.020 mm, the wound electrode body 20 may come out of the battery can 11 when the battery is dropped. If the thickness t exceeds 0.150 mm, the battery may rupture when the abnormal heat is applied to the battery.

A width w of the groove 11Gv is preferably 0.10 mm or more and 1.00 mm or less. If the width w is less than 0.10 mm, the battery may rupture when the abnormal heat is applied to the battery. If the width w exceeds 1.00 mm, the wound electrode body 20 may come out of the battery can 11 when the battery is dropped. An aperture angle θ of the groove 11Gv is, for example, 0 degrees or more and 90 degrees or less.

Preferably, gas relief pressure (cleavage pressure) of the groove 11Gv is preferably higher than gas relief pressure (operating pressure) of the safety valve mechanism 15. This is because, since the groove 11Gv of the can bottom 11Bt is configured to allow the gas to escape to the outside of the battery when the abnormal heat is applied to the battery, it is necessary to prevent the cleavage of the groove 11Gv during the normal use. The gas relief pressure of the groove 11Gv is preferably lower than internal pressure of the battery at which the sealing part of the battery is destroyed. This is because when the abnormal heat is applied to the battery, it is possible to cleave the groove 11Gv before the battery ruptures and discharge the gas to the outside of the battery. Specifically, the gas relief pressure of the groove 11Gv is preferably in a range of 20 kgf/cm² or more and 100 kgf/cm² or less.

For example, a cross-sectional shape of the groove 11Gv is a substantially polygonal shape, a substantially partial circular shape, a substantially partial elliptical shape, or an indefinite shape but is not limited thereto. An apex of the polygonal shape may have a curvature R or the like. Examples of the polygonal shape include a triangular shape, a quadrilateral shape such as a trapezoidal shape or a rectangular shape, and a pentagonal shape. Here, the “partial circular shape” is a part of a circular shape, for example, a semicircular shape. The partial oval shape is a part of an elliptical shape, for example, a semielliptical shape. In a case in which the groove 11Gv has a bottom surface, the bottom surface may be, for example, a flat surface, an uneven surface having a step difference, a curved surface having waviness, or a composite surface obtained by combining two or more of these surfaces.

### (Positive Electrode)

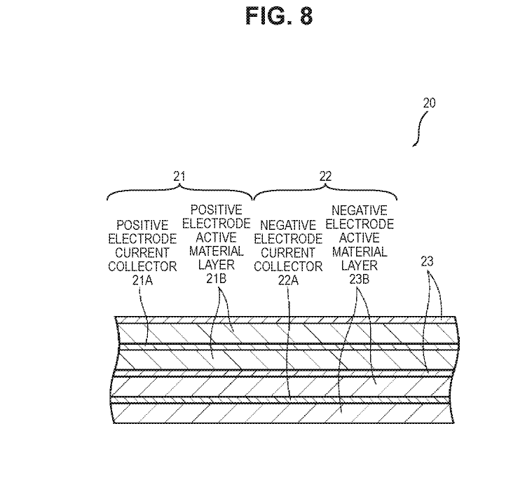

The positive electrode 21 has, as illustrated in FIG. 8, for example, a structure in which a positive electrode active material layer 21B is provided on both sides of a positive electrode current collector 21A. In addition, although not shown, the positive electrode active material layer 21B may be provided only on one side of the positive electrode current collector 21A. The positive electrode current collector 21A is made of metal foil, for example, aluminum foil, nickel foil, or stainless steel foil. The positive electrode active material layer 21B includes a positive electrode active material that can intercalate and deintercalate, for example, lithium (Li) serving as an electrode reactant. The positive electrode active material layer 21B may further include an additive as necessary. As the additive, for example, at least one of a conductive material and a binder can be used.

### (Positive Electrode Active Material)

As the positive electrode active material, for example, a lithium-containing compound such as lithium oxide, lithium phosphorus oxide, lithium sulfide, or an interlayer compound containing lithium is suitable, and two or more thereof may be mixed and used. In order to increase the energy density, a lithium-containing compound containing lithium, a transition metal element, and oxygen (O) is preferable. As the lithium-containing compound, for example, a lithium composite oxide having a layered rock-salt type structure indicated in Formula (A) or a lithium composite phosphate having an olivine type structure illustrated in Formula (B) may be used. As the lithium-containing compound, it is more preferable to use an element containing at least one type among elements of the group consisting of cobalt (Co), nickel (Ni), manganese (Mn), and iron (Fe) as the transition metal element. Examples of the lithium-containing compound include a lithium composite oxide having a layered rock-salt type structure indicated in Formula (C), Formula (D), or Formula (E), a lithium composite oxide having a spinel type structure indicated in Formula (F), and a lithium composite phosphate having an olivine type structure indicated in Formula (G), and specifically, LiNi_{0.50}Co_{0.20}Mn_{0.30}O₂, LiₐCoO₂ (a≈1), Li_{b}NiO₂ (b≈1), Li_{c1}Ni_{c2}Co_{1-c2}O₂ (c1≈1, 0<c2<1), Li_{d}Mn₂O₄ (d≈1), and LiₑFePO₄ (e≈1) are included.

LiₚNi_{(1-q-r)}Mn_{q}M1ᵣO_{(2-y)}X_{z} (A)

(Here, M1 in Formula (A) indicates at least one type among elements selected from Group 2 to Group 15 excluding nickel (Ni) and manganese (Mn). X indicates at least one type among elements of Group 16 and elements of Group 17 excluding oxygen (O). “p,” “q,” “y,” and “z” indicate values within ranges of 0≤p≤1.5, 0≤q≤1.0, 0≤r≤1.0, −0.10≤y≤0.20, and 0≤z≤0.2.)

LiₐM2_{b}PO₄ (B)

(Here, M2 in Formula (B) indicates at least one type among elements selected from Group 2 to Group 15. “a” and “b” indicate values within a range of 0≤a≤2.0 and 0.5≤b≤2.0).

Li_{f}Mn_{(1-g-b)}Ni_{g}M3ₕO₍₂₋ⱼ₎Fₖ (C)

(Here, M3 in Formula (C) indicates at least one type among elements of the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W). “f,” “g,” “h,” “j,” and “k” indicate values within ranges of 0.8≤f≤1.2, 0<g<0.5, 0≤h≤0.5, g+h<1, −0.1≤j≤0.2, and 0≤k≤0.1. Further, the lithium composition differs depending on the state of charging or discharging, and the value of “f” indicates a value in a fully discharged state.)

LiₘNi₍₁₋ₙ₎M4ₙO₍₂₋ₚ₎F_{q} (D)

(Here, M4 in Formula (D) indicates at least one type among elements of the group consisting of cobalt (Co), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). “m,” “n,” “p,” and “q” indicate values within ranges of 0.8≤m≤1.2, 0.005≤n≤0.5, −0.1≤p≤0.2, and 0≤q≤0.1. Further, the lithium composition differs depending on the state of charging or discharging, and the value of “m” indicates a value in a fully discharged state.)

LiᵣCo₍₁₋ₛ₎M5ₛO₍₂₋ₜ₎Fᵤ (E)

(Here, M4 in Formula (D) indicates at least one type among elements of the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). “m,” “n,” “p,” and “q” indicate values within ranges of 0.8≤r≤1.2, 0≤s<0.5, −0.1≤t≤0.2, and 0≤u≤0.1. Further, the lithium composition differs depending on the state of charging or discharging, and the value of “r” indicates a value in a fully discharged state.)

LiᵥMn_{2-w}M6_{w}OₓF_{y} (F)

(Here, M6 in Formula (D) indicates at least one type among elements of the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). “v,” “w,” “x,” and “y” indicate values within ranges of 0.9≤v≤1.1, 0≤w≤0.6, 3.7≤x≤4.1, and 0≤y≤0.1. Further, the lithium composition differs depending on the state of charging or discharging, and the value of “v” indicates a value in a fully discharged state.)

Li_{z}M7PO₄ (G)

(Here, M6 in Formula (D) indicates at least one type among elements of the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr). “z” indicates a value within a range of 0.9≤z≤1.1. Further, the lithium composition differs depending on the state of charging or discharging, and the value of “z” indicates a value in a fully discharged state.)

As the lithium-containing compound containing nickel (Ni), a compound in which Ni content is 80% or more is preferable. This is because if Ni content is 80% or more, a high battery capacity can be obtained. If the lithium-containing compound having the high Ni content is used, the battery capacity is increased as described above, whereas a gas generation amount (an oxygen discharging amount) of the positive electrode 21 becomes very large when the abnormal heat is applied. In the non-aqueous electrolyte secondary battery according to the first embodiment, an excellent effect of improving safety is obtained particularly when an electrode having a high gas generation amount is used.

As the lithium-containing compound having Ni content of 80% or more, a positive electrode material indicated in Formula (H) is preferable.

LiᵥNi_{w}M8ₓM9_{y}O_{z} (H)

(In Formula (H), 0<v<2, w+x+y≤1, 0.8≤w≤1, 0≤x≤0.2, 0≤y≤0.2, 0<z<3, and M8 and M9 are one or more types selected from cobalt (Co), iron (Fe), manganese (Mn), copper (Cu), zinc (Zn), aluminum (Al), chromium (Cr), vanadium (V), titanium (Ti), magnesium (Mg), and zirconium (Zr).)

In addition to the above-mentioned elements, as the positive electrode material capable of occluding and discharging lithium, there are inorganic compounds containing no lithium such as MnO₂, V₂O₅, V₆O₁₃, NiS, and MoS.

Any other element may be used as the positive electrode material capable of occluding and discharging lithium. Further, an arbitrary combination of two or more types among the positive electrode materials mentioned above may be mixed.

### (Binder)

As the binder, at least one selected from among, for example, resin materials such as polyvinylidene fluoride (PVdF), polytetrafluoroethylene (PTFE), polyacrylonitrile (PAN), styrene butadiene rubber (SBR), and carboxymethylcellulose (CMC), and a copolymer including such a resin material as a main component is used.

### (Conductive Material)

As the conductive material, for example, a carbon material such as graphite, carbon black or Ketjen black is used, and one or two or more thereof are used in combination. In addition, any metal material or conductive polymer material that is a material having conductivity may be used in addition to the carbon material.

### (Negative Electrode)

The negative electrode 22 has, as illustrated in FIG. 8, for example, a structure in which negative electrode active material layers 22B are provided on the both sides of a negative electrode current collector 22A. In addition, the negative electrode active material layer 22B may be provided only on one side of the negative electrode current collector 22A, this not shown in any figure. The negative electrode current collector 22A is made of metal foil, for example, copper foil, nickel foil or stainless steel foil.

The negative electrode active material layer 22B includes one or two or more negative electrode active materials that can intercalate and deintercalate lithium as a negative electrode active material. The negative electrode active material layer 22B may further include an additive such as a binder as necessary.

In addition, in the non-aqueous electrolyte secondary battery according to the first embodiment, an electrochemical equivalent of a negative electrode material that can intercalate and deintercalate lithium is greater than an electrochemical equivalent of the positive electrode 21, and a lithium metal is not precipitated in the negative electrode 22 during charging.

As the negative electrode material that can intercalate and deintercalate lithium, a material that can intercalate and deintercalate, for example, lithium, and includes at least one of a metal element and a metalloid element as a constituent element is used. Here, the negative electrode 22 including such a negative electrode material is referred to as an alloy-based negative electrode. This is because a high energy density can be obtained with use of such a material. Such a material is preferably used together with carbon material because the high energy density and also excellent cycling characteristics can be obtained. The negative electrode material may be a simple substance, an alloy, or a compound of the metal element or the semi-metal element, or may contain, at least partly, a phase of one or more of the simple substance, alloy, or compound of the metal element or the semi-metal element. Note that in the present technology, the alloy includes a material formed with two or more kinds of metal elements and a material containing one or more kinds of metal elements and one or more kinds of semi-metal elements. Further, the alloy may contain a non-metal element. Examples of its texture include a solid solution, a eutectic (eutectic mixture), an intermetallic compound, and one in which two or more kinds thereof coexist.

Examples of the metal element or semi-metal element contained in this negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). These materials may be crystalline or amorphous.

It is preferable to use, as the negative electrode active material, for example, a material containing, as a constituent element, a metal element or a semi-metal element of 4B group in the short periodical table. It is more preferable to use a material containing at least one of silicon (Si) and tin (Sn) as a constituent element. This is because silicon (Si) and tin (Sn) each have a high capability of intercalating and deintercalating lithium (Li), so that a high energy density can be obtained.

Examples of the alloy of tin (Sn) include alloys containing, as a second constituent element other than tin (Sn), at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of the alloy of silicon (Si) include alloys containing, as a second constituent element other than silicon (Si), at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of the compound of tin (Sn) or the compound of silicon (Si) include compounds containing oxygen (O) or carbon (C), which may contain any of the above-described second constituent elements in addition to tin (Sn) or silicon (Si). Specific examples of a compound of tin (Sn) include a silicon oxide represented by SiOᵥ (0.2<v<1.4).

Examples of the negative electrode material capable of intercalating and deintercalating lithium include, for example, carbon materials such as hardly graphitizable carbon, easily graphitizable carbon, graphite, thermally degraded carbons, cokes, glassy carbons, fired bodies of organic polymers, carbon fiber and activated carbon. As the graphite, natural graphite that has undergone a spheroidizing treatment or artificial graphite having a substantially spherical shape is preferably used. As the artificial graphite, artificial graphite obtained by graphitizing mesocarbon microbeads (MCMBs) or artificial graphite obtained by graphitizing and pulverizing a coke raw material is preferable. Among these, the cokes include pitch cokes, needle cokes, petroleum cokes and the like. The fired bodies of organic polymers are carbons obtained by firing polymer materials such as phenol resin and furan resin at an appropriate temperature, and some of these are categorized as hardly graphitizable carbon or easily graphitizable carbon. Moreover, the polymer materials include polyacetylene, polypyrrole and the like. These carbon materials are preferable for which change in crystal structure arising in charging or discharging is exceedingly small and which can attain high charge/discharge capacity and favorable cycle characteristics. Particularly, graphite is preferable which has a large electrochemical equivalent and can attain high energy density. Moreover, hardly graphitizable carbon is preferable which can attain excellent characteristics. Furthermore, one which is low in charge/discharge potential, specifically, close to lithium metal in charge/discharge potential is preferable since it can easily realize high energy density of the battery.

As the negative electrode material that can intercalate and deintercalate lithium, other metal compounds or polymer materials may be additionally exemplified. Examples of other metal compounds include an oxide such as MnO₂, V₂O₅, and V₆O₁₃, a sulfide such as NiS and MoS, or a lithium nitride such as LiN₃. Examples of the polymer materials include polyacetylene, polyaniline, and polypyrrole.

### (Binder)

As the binder, at least one selected from among, for example, resin materials such as polyvinylidene fluoride (PVdF), polytetrafluoroethylene (PTFE), polyacrylonitrile (PAN), styrene butadiene rubber (SBR), and carboxymethylcellulose (CMC), and a copolymer including such a resin material as a main component is used.

### (Separator)

The separator 23 separates the positive electrode 21 and the negative electrode 22, prevents a current short circuit due to contact of both electrodes, and allows lithium ions to pass. The separator 23 includes, for example, a porous membrane made of a synthetic resin including polytetrafluoroethylene, polypropylene or polyethylene or a porous membrane made of a ceramic, and may have a structure in which two or more of such porous membranes are laminated. Among these, a porous membrane made of a polyolefin is preferable because it has an excellent short circuit preventing effect and can improve safety of a battery according to a shutdown effect. In particular, the polyethylene is preferable as a material of the separator 23 because it can have a shutdown effect in a range of 100° C. or higher and 160° C. or lower and has excellent electrochemical stability. In addition, the polypropylene is preferable. Also, as long as a resin has chemical stability, it can be used in copolymerization or blending with polyethylene or polypropylene.

### (Electrolyte Solution)

The separator 23 is impregnated with an electrolyte solution which is electrolyte in a liquid form. The electrolyte solution contains a solvent and an electrolyte salt dissolved in the solvent. In order to improve a battery characteristic, the electrolyte solution may include a known additive.

As the solvent, a cyclic carbonate such as ethylene carbonate and propylene carbonate can be used and it is preferable to use one of ethylene carbonate and propylene carbonate, particularly, a mixture of both. This is because cycle characteristics can be improved.

In addition to these cyclic carbonates, as the solvent, an open-chain carbonate such as diethyl carbonate, dimethyl carbonate, ethyl methyl carbonate and methyl propyl carbonate is preferable to be used as a mixture with those. This is because high ion conductivity can be attained.

Furthermore, the solvent is preferable to contain 2,4-difluoroanisole and/or vinylene carbonate. This is because 2,4-difluoroanisole can improve discharge capacity and vinylene carbonate can improve cycle characteristics. Accordingly, mixing these to be used is preferable since the discharge capacity and the cycle characteristics can be improved.

Other than these, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitro methane, nitroethane, sulfolane, dimethylsulfoxide, and trimethyl phosphate.

In addition, a compound obtained by substituting fluorine for at least part of hydrogen of any of these non-aqueous solvents is sometimes preferable since reversibility of the electrode reaction can be sometimes improved depending on kinds of electrodes used as a combination.

Examples of the electrolyte salt include, for example, lithium salts, one kind of them may be used solely and two or more kinds of them may be mixed to be used. Examples of the lithium salts include LiPF₆, LiBF₄, LiAsF6, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bisoxalatoborate, and LiBr. Above all, LiPF₆ is preferable to be able to attain high ion conductivity and improve cycle characteristics.

In the non-aqueous electrolyte secondary battery having the above-described configuration, when charging is performed, for example, lithium ions are deintercalated from the positive electrode active material layer 21B, and intercalated into the negative electrode active material layer 22B through the electrolyte solution. In addition, when discharging is performed, for example, lithium ions are deintercalated from the negative electrode active material layer 22B and intercalated into the positive electrode active material layer 21B through the electrolyte solution.

### [Operation of the Battery]

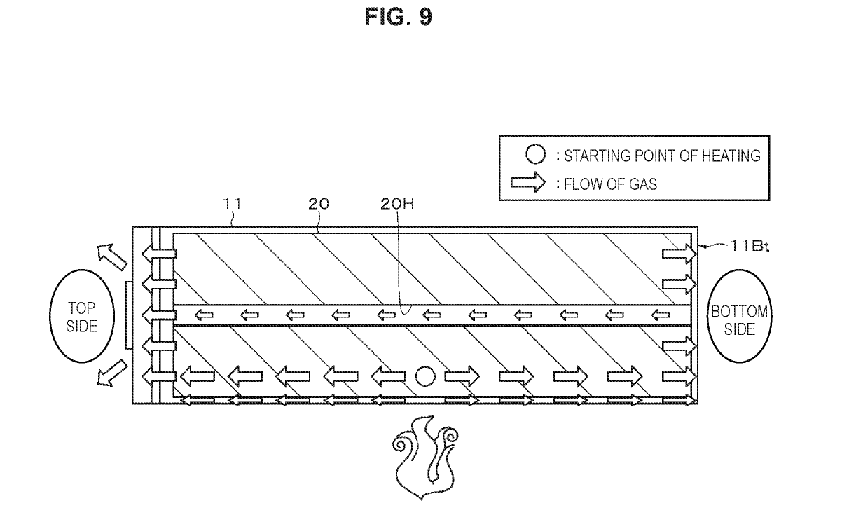

In the non-aqueous electrolyte secondary battery having the above configuration, when the abnormal heat is applied to the battery from the outside, gas is generated from a heating part or an electrode therearound, and the generated gas flows to the top side and the bottom side of the battery as illustrated in FIG. 9. The gas flowing to the top side is discharged to the outside via the cleaved safety valve mechanism (not illustrated). On the other hand, the gas flowing to the bottom side goes around to the top side via the center hole 20H of the wound electrode body 20 and is discharged to the outside via the cleaved safety valve mechanism.

In a case in which the generated gas amount is small, and the center hole 20H of the wound electrode body 20 is sufficiently large, the gas flowing to the bottom side smoothly goes around to the top side and is discharged to the outside via the cleaved safety valve mechanism, and thus the gas pressure of the bottom side of the battery is less often increased abnormally. On the other hand, in a case in which the generated gas amount is large and the center hole 20H of the wound electrode body 20 does not have a sufficient size, the amount of the gas flowing to the bottom side increases, it is difficult for the gas flowing to the bottom side to go around to the top side via the center hole 20H, and thus the gas pressure of the bottom side of the battery is likely to be abnormally increased. Particularly, in the non-aqueous electrolyte secondary battery of high capacity and high power, the gas pressure is likely to abnormally increase on the bottom side of the battery.

In the non-aqueous electrolyte secondary battery having the above-described configuration, when the gas pressure of the bottom side is abnormally increased, it is possible to appropriately cleave the groove 11Gv and appropriately discharge the gas accumulated on the can bottom 11Bt. At this time, the wound electrode body 20 does not come out from the cleaved can bottom 11Bt, and only the gas accumulated on the can bottom 11Bt can be released from the can bottom 11Bt.

### [Method of Manufacturing Battery]

The following will show an example of a method for manufacturing the non-aqueous electrolyte secondary battery according to the first embodiment of the present technology.

First, for example, a positive electrode mixture is prepared by mixing a first positive electrode active material, a second conductive material, and a binder, and a paste-form positive electrode mixture slurry is produced by dispersing the positive electrode mixture into a solvent such as N-methyl-2-pyrrolidinone. Next, the positive electrode mixture slurry is applied on the positive electrode current collector 21A, the solvent is dried, and the dried mixture is compression molded with a rolling press machine or the like, so that the positive electrode active material layer 21B is formed and the positive electrode 21 is formed.

Further, for example, a negative electrode mixture is produced by mixing a negative electrode active material and a binder, and a paste-form negative electrode mixture slurry is prepared by dispersing this negative electrode mixture in a solvent such as N-methyl-2-pyrrolidone. Next, the negative electrode mixture slurry is applied on the negative electrode current collector 22A, the solvent is dried, and the dried mixture is compression molded with a rolling press machine or the like, so that the negative electrode active material layer 22B is formed and the negative electrode 22 is produced.

Next, the positive electrode lead 25 is attached to the positive electrode current collector 21A by welding or the like, and the negative electrode lead 26 is attached to the negative electrode current collector 22A by welding or the like. Next, the positive electrode 21 and the negative electrode 22 are wound via the separator 23. Next, the tip part of the positive electrode lead 25 is welded to the safety valve mechanism 15, the tip part of the negative electrode lead 26 is welded to the battery can 11, and the wound positive electrode 21 and negative electrode 22 are interposed between the pair of insulator plates 12 and 13 and are contained inside the battery can 11. Next, after the positive electrode 21 and the negative electrode 22 are contained inside the battery can 11, the electrolyte solution is injected into the battery can 11 to impregnate the separator 23. Next, the battery lid 14, the safety valve mechanism 15 and the positive temperature coefficient element 16 are fixed to the opening end part of the battery can 11 by swaging via the opening sealing gasket 17. Thereby, the secondary battery shown in FIG. 1 is obtained.

### [Effects]

According to the first embodiment, the inside surface of the can bottom 11Bt includes the two or more grooves 11Gv on the same circumference. Further, the proportion Ra of the inner diameter Rᵢₙ of the groove 11Gv with respect to the outer diameter Rₒᵤₜ of the can bottom 11Bt is 44% or more, and the proportion Rb of the total value D of the intervals of the grooves 11Gv to the perimeter L of the circumference on which the grooves 11Gv are formed is 2% or more and 24% or less. Accordingly, when the abnormal heat is applied to the battery, it is possible to appropriately cleave the groove 11Gv and prevent the rupture of the battery in accordance with the abnormal increase in the gas pressure in the battery can 11 so that the wound electrode body 20 does not come out from the battery can 11. Further, when the battery is dropped, it is also possible to cleave the groove 11Gv by a dropping impact and prevent the wound electrode body 20 from coming out from the battery can 11. Therefore, it is possible to improve safety when the abnormal heat is applied to the battery while suppressing a decrease in mechanical strength of the can bottom 11Bt of the battery can 11 (that is, the cleavage strength of the groove 11Gv).

The center pin 24 has a tubular shape as described above and functions as a flow path for guiding the generated gas from the bottom side of the battery to the top side when the gas is generated. If the center pin 24 is provided, it is possible to suppress the center hole 20H of the wound electrode body 20 from being crushed, but there are cases in which the center pin 24 is crushed by expansion of the wound electrode body 20, the center hole 20H of the wound electrode body 20 is not sufficiently large, and the gas pressure of the bottom side is abnormally increased. Particularly, in batteries of high capacity and high power, since the expansion of the wound electrode body 20 at the time of charging and discharging or when the abnormal heat is applied is large, the center hole 20H of the wound electrode body 20 is unlikely to be sufficiently large, and thus the gas pressure of the bottom side is likely to be abnormally increased. Therefore, it is effective to form the two or more grooves Gv in the can bottom 11Bt as described above in terms of the safety of the battery regardless of the presence or absence of the center pin 24.

### Modified Example

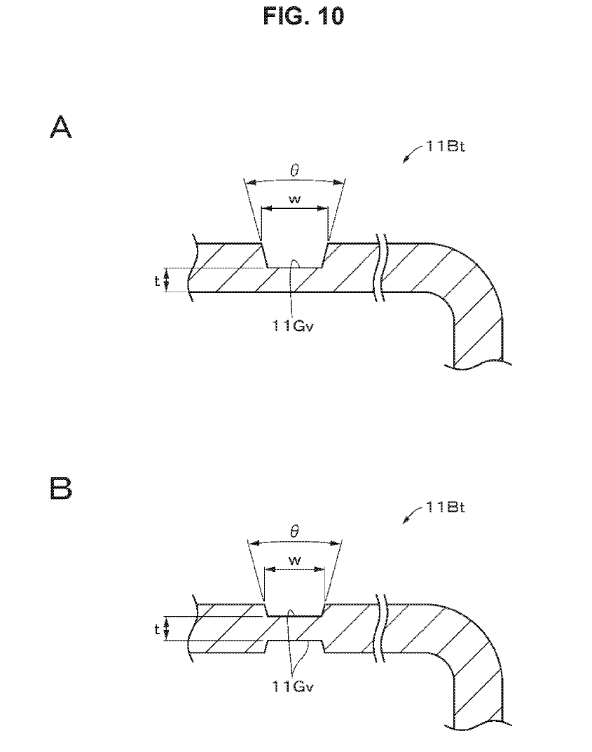

Of both surfaces of the can bottom 11Bt, a surface serving as an outside of the battery can 11 (hereinafter referred to simply as an “outside surface of the can bottom 11Bt”) has two or more grooves 11Gv on the same circumference as illustrated in FIG. 10A. Further, both the inside surface and the outside surface of the can bottom 11Bt may have two or more grooves 11Gv on the same circumference as illustrated in FIG. 10B.

In FIG. 10B, an example in which the groove 11Gv formed on the inside surface and the groove 11Gv formed on the outside surface are formed to overlap in the thickness direction of the can bottom 11Bt is illustrated, but the groove 11Gv formed on the inside surface and the groove 11Gv formed on the outside surface may be formed to deviate from each other in an in-plane direction of the can bottom 11Bt without overlapping in the thickness direction of the can bottom 11Bt.

In the first embodiment described above, the battery including the center pin 24 has been described, but the battery may not include the center pin 24. In the battery having the above configuration, the center hole 20H of the wound electrode body 20 is unlikely to be sufficiently large due to the expansion of the wound electrode body 20, and thus a remarkable effect of improving safety is obtained through the groove 11Gv.

### 2. Second Embodiment

In a second embodiment, a battery pack and an electronic device including the non-aqueous electrolyte secondary battery according to the first embodiment will be described.

### [Configuration of Battery Pack and Electronic Device]

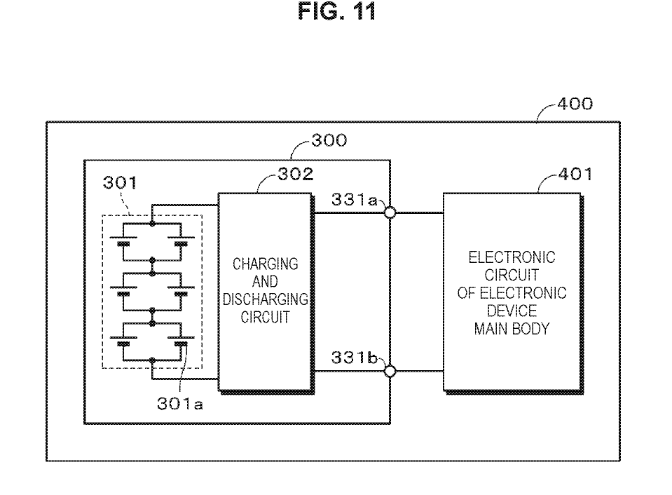

A configuration example of a battery pack 300 and an electronic device 400 according to the second embodiment of the present technology will be described below with reference to FIG. 11. The electronic device 400 includes an electronic circuit 401 of an electronic device main body and the battery pack 300. The battery pack 300 is electrically connected to the electronic circuit 401 through a positive electrode terminal 331a and a negative electrode terminal 331b. The electronic device 400 has, for example, a configuration in which the battery pack 300 is detachable by a user. However, the configuration of the electronic device 400 is not limited thereto, and a configuration in which the battery pack 300 is built in the electronic device 400 so that the user is unable to remove the battery pack 300 from the electronic device 400 may be used.

When the battery pack 300 is charged, the positive electrode terminal 331a and the negative electrode terminal 331b of the battery pack 300 are connected to a positive electrode terminal and a negative electrode terminal of a charger (not shown), respectively. On the other hand, when the battery pack 300 is discharged (when the electronic device 400 is used), the positive electrode terminal 331a and the negative electrode terminal 331b of the battery pack 300 are connected to a positive electrode terminal and a negative electrode terminal of the electronic circuit 401, respectively.

Examples of the electronic device 400 include a notebook personal computer, a tablet computer, a mobile phone (for example, a smartphone), a personal digital assistant (PDA), a display device (an LCD, an EL display, an electronic paper, and the like), an imaging device (for example, a digital still camera and a digital video camera), an audio device (for example, a portable audio player), a game device, a cordless phone extension unit, an E-book, an electronic dictionary, a radio, a headphone, a navigation system, a memory card, a pacemaker, a hearing aid, an electric tool, an electric shaver, a refrigerator, an air conditioner, a TV, a stereo, a water heater, a microwave, a dishwasher, a washing machine, a dryer, a lighting device, a toy, a medical device, a robot, a load conditioner, and a traffic light, and the present technology is not limited thereto.

### (Electronic Circuit)

The electronic circuit 401 includes, for example, a CPU, a peripheral logic unit, an interface unit, and a storage unit, and controls the entire electronic device

### (Battery Pack)

The battery pack 300 includes an assembled battery 301 and a charging and discharging circuit 302. The assembled battery 301 includes a plurality of secondary batteries 301a that are connected in series and/or parallel. The plurality of secondary batteries 301a are connected, for example, in n parallel m series (n and m are positive integers). In addition, FIG. 11 shows an example in which six secondary batteries 301a are connected in 2 parallel 3 series (2P3S). As the secondary battery 301a, the non-aqueous electrolyte secondary battery according to the first embodiment is used.

The charging and discharging circuit 302 is a control unit that controls charging and discharging of the assembled battery 301. Specifically, when charging is performed, the charging and discharging circuit 302 controls charging of the assembled battery 301. On the other hand, when discharging is performed (that is, when the electronic device 400 is used), the charging and discharging circuit 302 controls discharging of the electronic device 400.

### Modified Example

In the second embodiment described above, the example in which the battery pack 300 includes the assembled battery 301 configured with a plurality of secondary batteries 301a has been described, but the battery pack 300 may be configured to include a single secondary battery 301a instead of the assembled battery 301.

### 3. Third Embodiment

In a third embodiment, a power storage system in which the non-aqueous electrolyte secondary battery according to the first embodiment is included in a power storage device will be described. The power storage system may be any system that uses power and also includes a simple power device. The power system includes, for example, a smart grid, a home energy management system (HEMS), and a vehicle, and can store power.

### [Configuration of Power Storage System]

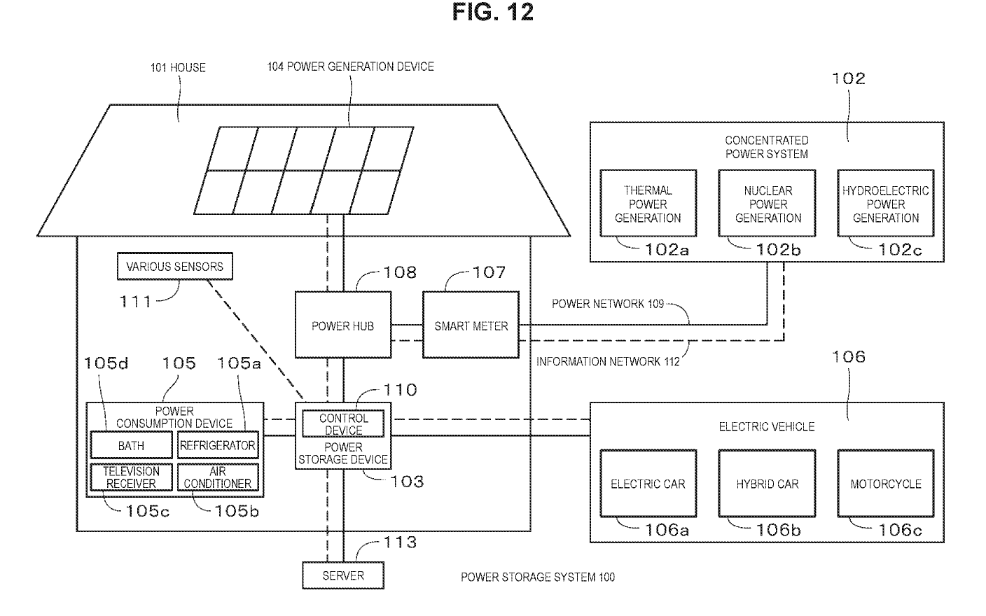

A configuration example of a power storage system (power system) 100 according to the third embodiment will be described below with reference to FIG. 12. The power storage system 100 is for a house, and power is supplied to the power storage device 103 from a concentrated power system 102 including thermal power generation 102a, nuclear power generation 102b, hydroelectric power generation 102c, and the like, via a power network 109, an information network 112, a smart meter 107, a power hub 108, and the like. Further, power is supplied to the power storage device 103 from an independent power source such as a home power generation device 104. Power supplied to the power storage device 103 is stored, and power to be used in the house 101 is fed with use of the power storage device 103. The same power storage system can be used not only in the house 101 but also in a building.

The house 101 is provided with the home power generation device 104, a power consumption device 105, the power storage device 103, a control device 110 which controls each device, the smart meter 107, the power hub 108, and sensors 111 which acquires various pieces of information. The devices are connected to each other by the power network 109 and the information network 112. As the home power generation device 104, a solar cell, a fuel cell, or the like is used, and generated power is supplied to the power consumption device 105 and/or the power storage device 103. Examples of the power consumption device 105 include a refrigerator 105a, an air conditioner 105b, a television receiver 105c, a bath 105d, and the like. Examples of the power consumption device 105 further include an electric vehicle 106 such as an electric car 106a, a hybrid car 106b, a motorcycle 106c, or the like.

The power storage device 103 includes the non-aqueous electrolyte secondary battery according to the first embodiment of the present technology. Functions of the smart meter 107 include measuring the used amount of commercial power and transmitting the measured used amount to a power company. The power network 109 may be any one or more of DC power supply, AC power supply, and contactless power supply.

Examples of the various sensors 111 include a motion sensor, an illumination sensor, an object detecting sensor, a power consumption sensor, a vibration sensor, a touch sensor, a temperature sensor, an infrared sensor, and the like. Information acquired by the various sensors 111 is transmitted to the control device 110. With the information from the sensors 111, weather conditions, people conditions, and the like are caught, and the power consumption device 105 is automatically controlled so as to make the energy consumption minimum. Further, the control device 110 can transmit information about the house 101 to an external power company via the Internet, for example.

The power hub 108 performs processes such as branching off power lines and DC/AC conversion. Examples of communication schemes of the information network 112 connected to the control device 110 include a method using a communication interface such as UART (Universal Asynchronous Receiver/Transceiver), and a method using a sensor network according to a wireless communication standard such as Bluetooth (registered trademark), ZigBee, or Wi-Fi. A Bluetooth (registered trademark) scheme can be used for multimedia communication, and one-to-many connection communication can be performed. ZigBee uses a physical layer of IEEE (Institute of Electrical and Electronics Engineers) 802.15.4. IEEE802.15.4 is the name of a near-field wireless network standard called PAN (Personal Area Network) or W (Wireless) PAN.

The control device 110 is connected to an external server 113. The server 113 may be managed by any of the house 101, an electric company, and a service provider. Examples of information transmitted and received by the server 113 include power consumption information, life pattern information, electric fee, weather information, natural disaster information, and information about power trade. Such information may be transmitted and received by the power consumption device (e.g., the television receiver) in the house, or may be transmitted and received by a device (e.g., a mobile phone) outside the house. Further, such information may be displayed on a device having a display function, such as the television receiver, the mobile phone, or the PDA (Personal Digital Assistant).

The control device 110 controlling each part is configured with a CPU (Central Processing Unit), a RAM (Random Access Memory), a ROM (Read Only Memory), and the like, and is stored in the power storage device 103 in this example. The control device 110 is connected to the power storage device 103, the home power generation device 104, the power consumption device 105, the various sensors 111, and the server 113 via the information network 112, and has a function of adjusting the used amount of commercial power and the power generation amount, for example. Note that the control device 110 may further have a function of performing power trade in the power market.

As described above, power generated by not only the concentrated power system 102 such as the thermal power generation 102a, the nuclear power generation 102b, and the hydroelectric power generation 102c, but also the home power generation device 104 (solar power generation or wind power generation) can be stored in the power storage device 103. Therefore, even when the power generated by the home power generation device 104 varies, the amount of power supplied to the outside can be constant, or only necessary discharge can be controlled. For example, power generated by the solar power generation can be stored in the power storage device 103 and also inexpensive power at midnight can be stored in the power storage device 103 during nighttime, so that power stored in the power storage device 103 can be discharged and used when the power fee is expensive during daytime.

Note that although this example shows the control device 110 housed in the inside of the power storage device 103, the control device 110 may be housed in the inside of the smart meter 107 or configured independently. Further, the power storage system 100 may be used for a plurality of houses in a multiple dwelling house or a plurality of separate houses.

### 4. Fourth Embodiment

In a fourth embodiment, an electric vehicle including the non-aqueous electrolyte secondary battery according to the first will be described.

### [Configuration of Electric Car]

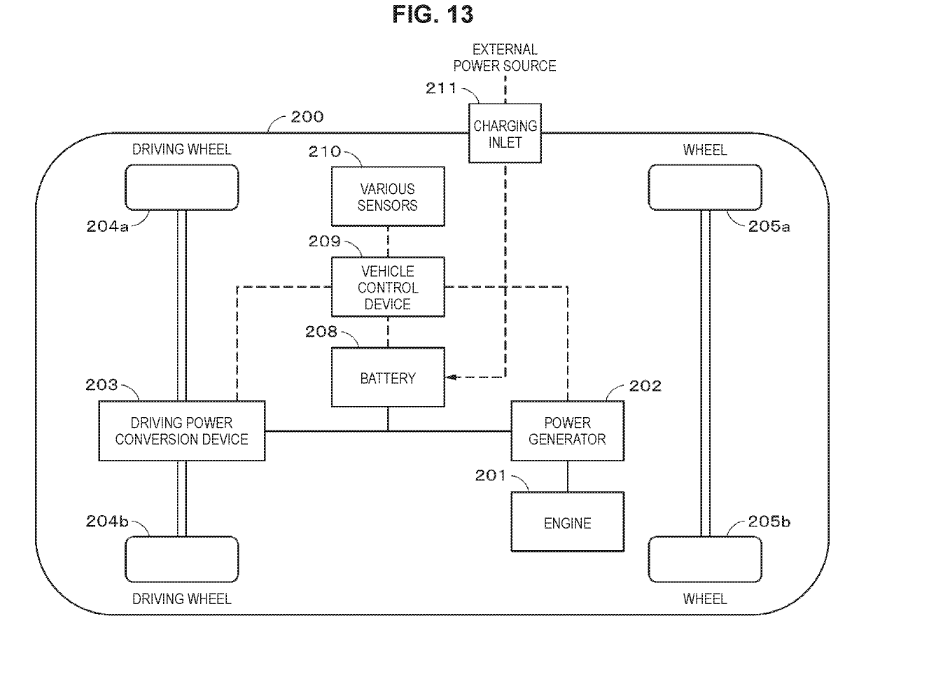

A configuration of an electric vehicle according to the fourth embodiment of the present technology will be described with reference to FIG. 13. The hybrid vehicle 200 is a hybrid vehicle that uses a series hybrid system. The series hybrid system vehicle is a vehicle that uses power generated by a power generator that is moved by an engine or power that is generated by a power generator and stored temporarily in a battery and is operated by a driving power conversion device 203.

A hybrid vehicle 200 incorporates an engine 201, a power generator 202, the driving power conversion device 203, driving wheels 204a and 204b, wheels 205a and 205b, a battery 208, a vehicle control device 209, various sensors 210, and a charging inlet 211. For the battery 208, the non-aqueous electrolyte secondary battery according to the first embodiment of the above-described present technology is used.

The hybrid vehicle 200 runs by using the driving power conversion device 203 as a power source. One of examples of the driving power conversion device 203 is a motor. Power in the battery 208 drives the driving power conversion device 203, and the rotating power of the driving power conversion device 203 is transmitted to the driving wheels 204a and 204b. Note that by using DC/AC conversion or AC/DC conversion in a necessary portion, an alternate current motor or a direct current motor can be used for the driving power conversion device 203. The various sensors 210 control the number of engine rotation via the vehicle control device 209 and controls the aperture of an unshown throttle valve (throttle aperture). The various sensors 210 include a speed sensor, an acceleration sensor, a sensor of the number of engine rotation, and the like.

The rotating power of the engine 201 is transmitted to the power generator 202, and power generated by the power generator 202 with the rotating power can be stored in the battery 208.

When the hybrid vehicle 200 reduces the speed with an unshown brake mechanism, the resisting power at the time of the speed reduction is added to the driving power conversion device 203 as the rotating power, and regenerative power generated by the driving power conversion device 203 with this rotating power is stored in the battery 208.

The battery 208 is connected to a power source outside the hybrid vehicle 200 through the charging inlet 211, receives power supply from the external power source using the charging inlet 211 as an input port, and can accumulate the received power.

Although not shown, an information processing device which performs information processing about vehicle control based on information about the non-aqueous electrolyte secondary battery may be provided. Examples of such an information processing device include an information processing device which displays the remaining battery based on information about the remaining non-aqueous electrolyte secondary battery.

Note that the above description is made by taking an example of the series hybrid car which runs with a motor using power generated by a power generator driven by an engine or power obtained by storing the power in a battery. However, an embodiment of the present technology can also be applied effectively to a parallel hybrid car which uses the output of an engine and a motor as the driving power source and switches three modes as appropriate: driving with the engine only; driving with the motor only; and driving with the engine and the motor. Further, an embodiment of the present technology can also be applied effectively to a so-called electric vehicle which runs by being driven with a driving motor only, without an engine.

### Example

The present technology will be described below in detail with reference to examples and the present technology is not limited to the following examples.

Examples of the present technology will be described in the following order.

i. Sample in which proportions Ra and Rb are changed
ii. Sample in which thickness t of can bottom in groove bottom or width w of groove is changed
<Sample in which Proportions Ra and Rb are Changed>

### Examples 1-1 to 1-4 and Comparative Examples 1-1 and 1-2

### (Positive Electrode Manufacturing Process)

The positive electrode was manufactured as follows. First, lithium carbonate (Li₂CO₃) and cobalt carbonate (CoCO₃) were mixed at a molar ratio of 0.5:1 and then calcined in the air at 900° C. for 5 hours, so that a lithium cobalt composite oxide (LiCoO₂) was obtained as the positive electrode active material. Then, 91 parts by mass of the lithium cobalt composite oxide obtained as described above, 6 parts by mass of graphite serving as a conductive agent, and 3 parts by mass of polyvinylidene fluoride serving as a binder were mixed to prepare a positive electrode mixture, and it was dispersed in N-methyl-2-pyrrolidone to prepare a paste-like positive electrode mixture slurry. Then, both sides of a positive electrode collector made of strip-shaped aluminum foil (12 μm thickness) were coated with the positive electrode mixture slurry, then dried, and compression-molded by a roll press machine to form a positive electrode active material layer. Then, a positive electrode lead made of aluminum was welded and attached to one end of the positive electrode collector.

### (Negative Electrode Manufacturing Process)

The negative electrode was manufactured as follows. First, 97 parts by mass of artificial graphite powder serving as a negative electrode active material and 3 parts by mass of polyvinylidene fluoride serving as a binder were mixed to prepare a negative electrode mixture, and it was then dispersed in N-methyl-2-pyrrolidone to prepare a paste-like negative electrode mixture slurry. Then, both sides of a negative electrode collector made of strip-shaped copper foil (15 μm thickness) were coated with the negative electrode mixture slurry, then dried, and compression-molded by a roll press machine to form a negative electrode active material layer. Then, the negative electrode lead made of nickel was attached to one end of the negative electrode collector.

### (Battery Assembling Process)

The battery was assembled as follows. First, the positive electrode and the negative electrode obtained as described above were stacked with a separator made of a microporous polyethylene stretch film having a thickness of 23 μm interposed therebetween in the order of the negative electrode, the separator, the positive electrode, and the separator and wound around twice or more, and thus a jelly roll type wound electrode body was obtained.

Then, a battery can with an outer diameter of 18.20 mm included in a can bottom having the following configuration was prepared.

Groove shape: arc shape

Number of grooves: 2 (same length)

Arrangement of groove: equal interval arrangement (rotational symmetry with respect to can bottom center)

Outer diameter (diameter) Rₒᵤₜ of can bottom: 18.20 mm

Inner diameter (diameter) Rᵢₙ of groove: 4 mm to 16 mm

Proportion Ra (=(Rᵢₙ/Rₒᵤₜ)×100): 22% to 88%

Total value D of intervals d of grooves in circumferential direction: 0.3 mm to 1.0 mm

Perimeter L of circumference on which grooves are formed: 13 mm to 50 mm

Proportion Rb (=(D/L)×100): 2%

Thickness t of can bottom in bottom of groove: 0.075 mm

Width w of groove: 0.4 mm

Aperture angle of groove: 30°

Then, the wound electrode body was interposed between a pair of insulator plates, the negative electrode lead was welded to the battery can, the positive electrode lead was welded to the safety valve mechanism, and the wound electrode body was housed inside the battery can. Then, a non-aqueous electrolytic solution was prepared by dissolving LiPF₆ as an electrolyte salt to have a concentration of 1 mol/dm³ in a solvent in which ethylene carbonate and methylethyl carbonate were mixed at a volume ratio of 1:1.

Finally, after the electrolytic solution was injected into the battery can in which the wound electrode body was housed, a safety valve, a PTC element and a battery lid were fixed by caulking the battery can via an insulating sealing gasket, and thus a cylindrical non-aqueous electrolyte secondary battery (hereinafter referred to simply as a “battery”) having an outer diameter (diameter) of 18.20 mm and a height of 65 mm was prepared. Further, this battery was designed so that an open circuit voltage (that is, a battery voltage) in a fully charged state was 4.2 V by adjusting the positive electrode active material amount and the negative electrode active material amount, but in a test to be described later, an evaluation was performed at 4.4 V (an overcharged state exceeding a normal usable range voltage).

### Examples 2-1 to 2-4 and Comparative Examples 2-1 and 2-2

A battery was manufactured in a similar manner to that of the examples 1-1 to 1-4 and the comparative examples 1-1 and 1-2 except that the following configuration was changed for the groove of the can bottom.

Total value D of intervals d of grooves in circumferential direction: 1.0 mm to 4.0 mm

Rb: 8%

### Examples 3-1 to 3-4 and Comparative Examples 3-1 and 3-2

A battery was manufactured in a similar manner to that of the examples 1-1 to 1-4 and the comparative examples 1-1 and 1-2 except that the following configuration was changed for the groove of the can bottom.

Total value D of intervals d of grooves in circumferential direction: 1.5 mm to 6.0 mm

Rb: 12%

### Examples 4-1 to 4-4 and Comparative Examples 4-1 and 4-2

A battery was manufactured in a similar manner to that of the examples 1-1 to 1-4 and the comparative examples 1-1 and 1-2 except that the following configuration was changed for the groove of the can bottom.

Total value D of intervals d of grooves in circumferential direction: 3.0 mm to 12.0 mm

Rb: 24%

### Comparative Examples 5-1 to 5-6

A battery was manufactured in a similar manner to that of the examples 1-1 to 1-4 and the comparative examples 1-1 and 1-2 except that the shape of the groove was changed to an annular shape.

### Comparative Example 6-1 to 6-6

A battery was manufactured in a similar manner to that of the examples 1-1 to 1-4 and the comparative examples 1-1 and 1-2 except that the following configuration was changed for the groove of the can bottom.

Total value D of intervals d of grooves in circumferential direction: 3.8 mm to 15.0 mm

Rb: 30%

### (Evaluation)

For the batteries of the examples 1-1 to 4-4 and the comparative examples 1-1 to 6-6 obtained as described above, the following battery burning test and battery drop test were performed. These tests conform to official tests.

### (Battery Burning Test)

First, the center of the battery was burnt with a burner, and the number of batteries whose contents did not come out of the battery or which did not rupture was obtained. Then, a pass rate of the battery burning test was obtained from the following Formula:

(Pass rate r1 of battery burning test)=((number of batteries whose contents did not come out of battery or which did not rupture)/(number of batteries which underwent burning test))×100[%]

### (Battery Drop Test)

First, the battery was dropped from a height of 10 m 30 times, and the number of batteries whose contents did not come out of the battery was obtained. Then, a pass rate of the battery drop test was obtained from the following Formula:

(Pass rate r2 of battery drop test)=((number of batteries whose contents did not come out of battery)/(number of batteries which underwent drop test))×100[%]

Table 1 shows the test results for the batteries of the examples 1-1 to 4-4 and the comparative examples 1-1 to 6-6.

TABLE 1

| | Rb: 0% | Rb: 2% | Rb: 8% | Rb: 12% | Rb: 24% | Rb: 30% |
|---|---|---|---|---|---|---|
| Rin: 16 mm | (CEx. 5-1) | (Ex. 1-1) | (Ex. 2-1) | (Ex. 3-1) | (Ex. 4-1) | (CEx. 6-1) |
| L: 50 mm | D: 0 mm | D: 1.0 mm | D: 0.4 mm | D: 6.0 mm | D: 12.0 mm | D: 15.0 mm |
| Ra: 88% | r1: 20% (come out) | r1: 100% | r1: 100% | r1: 100% | r1: 100% | r1: 80% (rupture) |
| | r2: 60% | r2: 100% | r2: 100% | r2: 100% | r2: 100% | r2: 100% |
| Rin: 14 mm | (CEx. 5-2) | (Ex. 1-2) | (Ex. 2-2) | (Ex. 3-2) | (Ex. 4-2) | (CEx. 6-2) |
| L: 44 mm | D: 0 mm | D: 0.88 mm | D: 3.5 mm | D: 5.3 mm | D: 10.6 mm | D: 13.2 mm |
| Ra: 77% | r1: 20% (come out) | r1: 100% | r1: 100% | r1: 100% | r1: 100% | r1: 80% (rupture) |
| | r2: 100% | r2: 100% | r2: 100% | r2: 100% | r2: 100% | r2: 100% |
| Rin: 10 mm | (CEx. 5-3) | (Ex. 1-3) | (Ex. 2-3) | (Ex. 3-3) | (Ex. 4-3) | (CEx. 6-3) |
| L: 31 mm | D: 0 mm | D: 0.6 mm | D: 2.5 mm | D: 3.8 mm | D: 7.5 mm | D: 9.4 mm |
| Ra: 55% | r1: 20% (come out) | r1: 100% | r1: 100% | r1: 100% | r1: 100% | r1: 80% (rupture) |
| | r2: 100% | r2: 100% | r2: 100% | r2: 100% | r2: 100% | r2: 100% |
| Rin: 8 mm | (CEx. 5-4) | (Ex. 1-4) | (Ex. 2-4) | (Ex. 3-4) | (Ex. 4-4) | (CEx. 6-4) |
| L: 25 mm | D: 0 mm | D: 0.5 mm | D: 2.0 mm | D: 3.0 mm | D: 6.0 mm | D: 7.5 mm |
| Ra: 44% | r1: 20% (come out) | r1: 100% | r1: 100% | r1: 100% | r1: 100% | r1: 80% (rupture) |
| | r2: 100% | r2: 100% | r2: 100% | r2: 100% | r2: 100% | r2: 100% |
| Rin: 6 mm | (CEx. 5-5) | (CEx. 1-1) | (CEx. 2-1) | (CEx. 3-1) | (CEx. 4-1) | (CEx. 6-5) |
| L: 19 mm | D: 0 mm | D: 0.4 mm | D: 1.5 mm | D: 2.3 mm | D: 4.5 mm | D: 5.6 mm |
| Ra: 33% | r1: 20% (rupture) | r1: 80% (rupture) | r1: 80% (rupture) | r1: 80% (rupture) | r1: 80% (rupture) | r1: 80% (rupture) |
| | r2: 100% | r2: 100% | r2: 100% | r2: 100% | r2: 100% | r2: 100% |
| Rin: 4 mm | (CEx. 5-6) | (CEx. 1-2) | (CEx. 2-2) | (CEx. 3-2) | (CEx. 4-1) | (CEx. 6-6) |
| L: 13 mm | D: 0 mm | D: 0.3 mm | D: 1.0 mm | D: 1.5 mm | D: 3.0 mm | D: 3.8 mm |
| Ra: 22% | r1: 20% (rupture) | r1: 60% (rupture) | r1: 60% (rupture) | r1: 60% (rupture) | r1: 60% (rupture) | r1: 60% (rupture) |
| | r2: 100% | r2: 100% | r2: 100% | r2: 100% | r2: 100% | r2: 100% |

Meanings of the symbols in Table 1 are as follows.

Rᵢₙ: inner diameter of groove

L: perimeter of circumference on which grooves are formed

Ra: proportion of inner diameter Rᵢₙ of groove to outer diameter Rₒᵤₜ of can bottom

Rb: proportion of total value D of intervals of grooves to perimeter L of circumference on which grooves are formed

Ex.: example

CEx.: comparative example

D: total value D of intervals d of grooves in circumferential direction

r1: pass rate of battery burning test

r2: pass rate of battery drop test

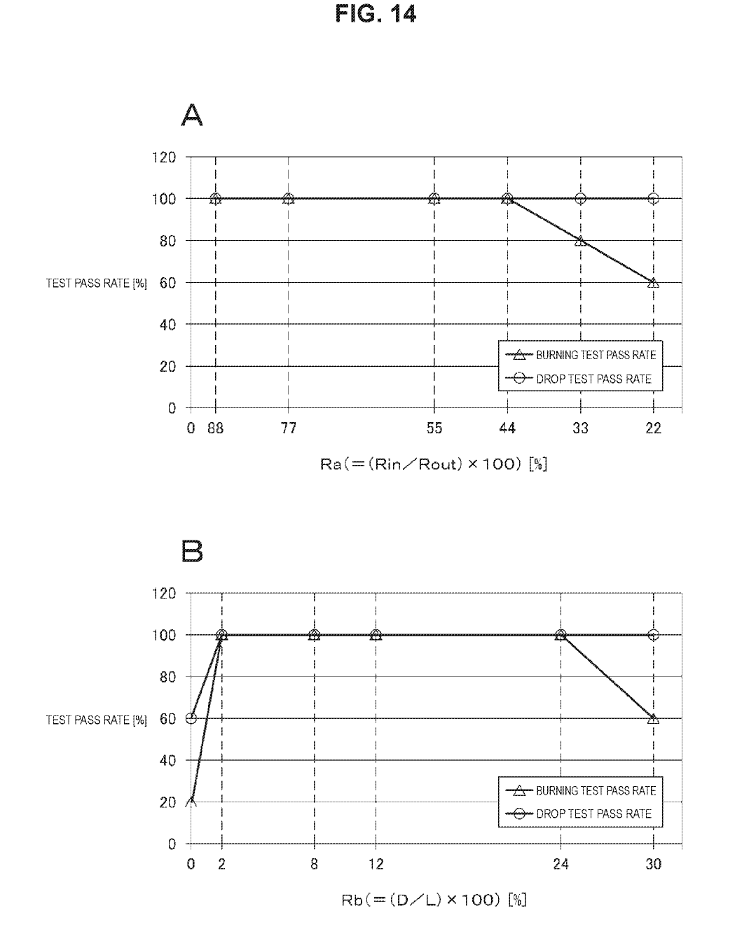

Among the above test results, the test results for the batteries of the examples 1-1 to 1-4 and the comparative examples 1-1 and 1-2 are representatively illustrated in FIG. 14A. The test results for the batteries of the examples 1-1, 2-1, 3-1, and 4-1 and the comparative examples 5-5 and 6-5 are representatively illustrated in FIG. 14B.

The following can be understood from Table 1, FIG. 14A, and FIG. 14B. If the proportion Ra is less than 44%, the pass rate of the burning test tends to decrease. This is because, since the groove is too far from the outer circumference part of the wound electrode body, and so it is difficult to soften the groove by heat generated during the burning test, it is difficult for the gas to escape to the outside of the can bottom without cleaving of the can bottom.

If the proportion Rb is less than 2%, the pass rate of the burning test tends to decrease. This is because, since the intervals between the groves are small, the entire can bottom is cleaved during the burning test, and the contents of the battery come out. If the proportion Rb is less than 2%, and the proportion Ra is 88% or more, the pass rate of the drop test also tends to decrease. This is because, since the intervals between the grooves are small, and the inner diameter of the groove is large, the cleavage strength of the groove is too low, and so the groove is cleaved in the drop test, and the contents of the battery come out. If the proportion Rb exceeds 24%, the pass rate of the burning test tends to decrease. This is because, since a joint is large, and the cleavage strength of the groove is high, the can bottom is not cleaved during the burning test, and the battery ruptures.

Therefore, in order to suppress the reduction in the pass rates of the drop test and the burning test, the proportion Ra is set to be 44% or more, and the proportion Rb is set to be 2% or more and 24% or less.

<ii. Sample in which Thickness t of can Bottom in Groove Bottom or Width w of Groove is Changed>

### Example 6-1 to 6-6

As shown in Table 2, a battery was obtained in a similar manner to that of the example 1-1 except that the thickness t of the can bottom in the bottom of the groove was changed in a range of 0.010 mm to 0.200 mm.

### Examples 7-1 to 7-7

As shown in Table 3, a battery was obtained in a similar manner to that of the example 1-1 except that the width t of the groove was changed in a range of 0.05 mm to 2.00 mm.

### (Evaluation)

For the batteries of the examples 6-1 to 6-6 and 7-1 to 7-7 obtained as described above, the battery burning test and the battery drop test were performed in a similar manner to that of the examples 1-1 to 4-4 and the comparative examples 1-1 to 6-6.

Table 2 shows test results for the examples 1-1 and 6-1 to 6-6.

TABLE 2

| | Thickness t of | Pass rate of | Pass rate of |
|---|---|---|---|
| | can bottom [mm] | burning test [%] | drop test [%] |
| Example 1-1 | 0.075 | 100 | 100 |
| Example 6-1 | 0.010 | 100 | 60 |
| Example 6-2 | 0.020 | 100 | 100 |
| Example 6-3 | 0.050 | 100 | 100 |
| Example 6-4 | 0.100 | 100 | 100 |
| Example 6-5 | 0.150 | 100 | 100 |
| Example 6-6 | 0.200 | 60 | 100 |

Table 3 shows test results for the examples 1-1 and 7-1 to 7-7.

TABLE 3

| | Width w of | Pass rate of | Pass rate of |
|---|---|---|---|
| | groove [mm] | burning test [%] | drop test [%] |
| Example 1-1 | 0.40 | 100 | 100 |
| Example 7-1 | 0.05 | 60 | 100 |
| Example 7-2 | 0.10 | 100 | 100 |
| Example 7-3 | 0.50 | 100 | 100 |
| Example 7-4 | 0.70 | 100 | 100 |
| Example 7-5 | 1.00 | 100 | 100 |
| Example 7-6 | 1.50 | 100 | 90 |
| Example 7-7 | 2.00 | 100 | 60 |

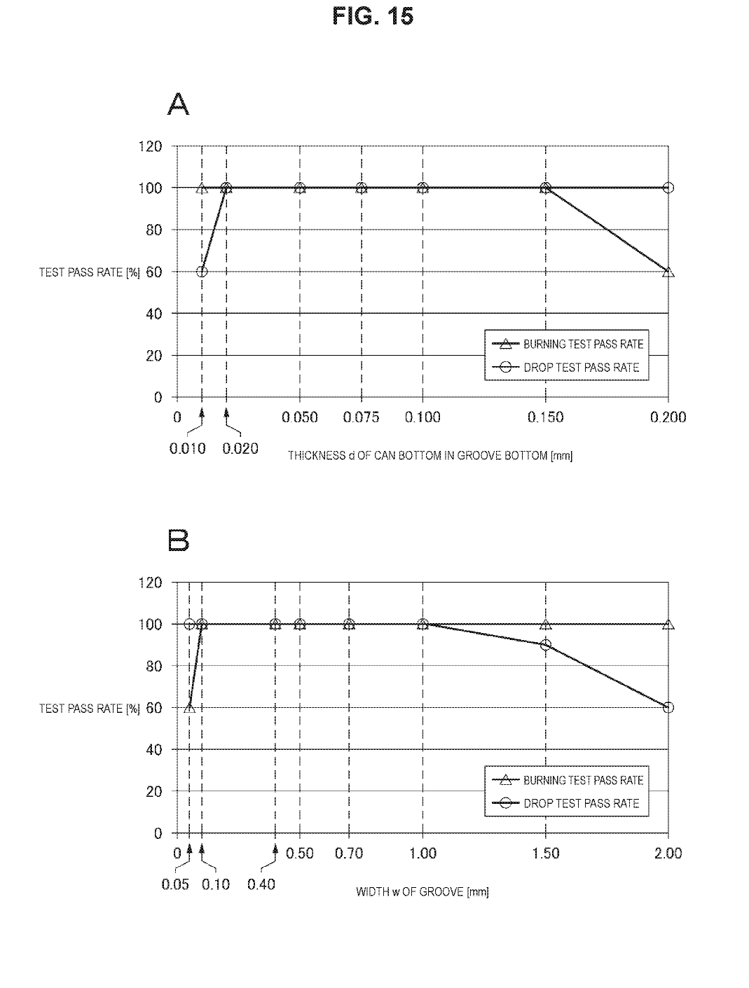

The test results for the batteries of the examples 1-1 and 6-1 to 6-6 are illustrated in FIG. 15A. The test results for the batteries of the examples 1-1 and 7-1 to 7-7 are illustrated in FIG. 15B.

The following can be understood from Table 2, Table 3, FIG. 15A, and FIG. 15B. If the thickness t of the bottom part in the groove bottom is less than 0.020 mm, the pass rate of the drop test tends to decrease. This is because, since the cleavage strength of the groove is too low, the groove is cleaved in the drop test, and the contents of the battery come out. If the thickness t of the bottom part in the groove bottom exceeds 0.150 mm, the pass rate of the burning test tends to decrease. This is because, since the cleavage strength of the groove (that is, the gas cleavage pressure of the groove) is too high, the side of the battery or the sealing part ruptures before the groove is cleaved, and the contents come out. If the width w of the groove 11Gv is less than 0.10 mm, the pass rate of the burning test tends to decrease. This is because, since the cleavage strength of the groove (that is, the gas cleavage pressure of the groove) is too high, the side of the battery or the sealing part ruptures before the groove is cleaved, and the contents come out. If the width w of the groove 11Gv exceeds 1.00 mm, the pass rate of the drop test tends to decrease. This is because, since the cleavage strength of the groove is too low, the groove is cleaved in the drop test, and the contents of the battery come out.

Therefore, in order to suppress the reduction in the pass rates of the drop test and the burning test, the thickness t of the can bottom in the bottom of the groove is set to be 0.020 mm or more and 0.150 mm or less, and the width w of the groove is set to be 0.10 mm or more and 1.00 mm or less.

The embodiments, variations thereof, and examples of the present technology have been specifically described above. However, the present technology is not limited to the above-described embodiments, variations thereof, and examples. Various modifications of the present technology can be made without departing from the technical spirit of the present technology.

For example, the configurations, the methods, the processes, the shapes, the materials, the numerical values, and the like mentioned in the above-described embodiments, variations thereof, and examples are merely examples. Different configurations, methods, processes, shapes, materials, numerical values, and the like may be used, as necessary.

Further, configuration, methods, processes, shapes, materials, numerical values and the like in the above-described embodiments, variations thereof, and examples may be combined insofar as they are not departing from the spirit of the present technology.

In the above embodiments, examples in which the present technology is applied to the lithium ion secondary battery have been described, but the present technology can be applied to secondary batteries other than the lithium ion secondary battery and primary batteries. However, it is particularly effective to apply the present technology to the lithium ion secondary battery.

Additionally, the present technology may also be configured as below.

(1)

A battery, including:

an electrode body; and

a battery can configured to accommodate the electrode body and include a bottom part,

in which at least one surface of the bottom part has two or more grooves on a same circumference,

a proportion of an inner diameter of the groove to an outer diameter of the bottom part is 44% or more, and

a proportion of a total value of intervals of the grooves in a circumferential direction of the circle to a perimeter of the circle is 2% or more and 24% or less.

(2)

The battery according to (1),

in which a thickness of the bottom part in a bottom of the groove is 0.020 mm or more and 0.150 mm or less, and

a width of the groove is 0.10 mm or more and 1.00 mm or less.

(3)

The battery according to (1) or (2), further including:

a safety valve configured to discharge gas in the battery can.

(4)

The battery according to (3),

in which gas relief pressure of the groove is higher than gas relief pressure of the safety valve.

(5)

The battery according to any one of (1) to (4),

in which the circle is concentric with an outer circumference of the bottom part.

(6)

The battery according to any one of (1) to (5),

in which, of both surfaces of the bottom part, a surface serving as an inside or an outside of the battery can has the two or more grooves on the same circumference.

(7)

The battery according to any one of (1) to (6),

in which a cross-sectional shape of the groove is a substantially trapezoidal shape, a substantially rectangular shape, a substantially triangular shape, a substantially partial circular shape, a substantially partial elliptical shape, or an indefinite shape.

(8)

The battery according to any one of (1) to (7),

in which the electrode body includes a positive electrode and a negative electrode, and

an open circuit voltage in a fully charged state per pair of the positive electrode and the negative electrode is in a range of 4.4 V or more and 6.00 V or less.

(9)

The battery according to any one of (1) to (8),

in which the electrode body includes a positive electrode including a positive electrode active material having an average composition indicated by the following Formula (1):

LiᵥNi_{w}M′ₓM″_{y}O_{z} (1)

(here, 0<v<2, w+x+y≤1, 0.8≤w≤1, 0≤x≤0.2, 0≤y≤0.2, 0<z<3, and M′ and M″ are one or more types selected from cobalt (Co), iron (Fe), manganese (Mn), copper (Cu), zinc (Zn), aluminum (Al), chromium (Cr), vanadium (V), titanium (Ti), magnesium (Mg), and zirconium (Zr).)

(10)

A battery pack, including:

the battery according to any one of (1) to (9); and

a control unit configured to control the battery.

(11)

An electronic device, including:

the battery according to any one of (1) to (9),

in which the electronic device is supplied with electric power from the battery.

(12)

An electric vehicle, including:

the battery according to any one of (1) to (9);

a conversion device configured to be supplied with electric power from the battery and convert the electric power into driving power for the vehicle; and

a control device configured to perform information processing related to vehicle control on the basis of information related to the battery.

(13)

A power storage device, including:

the battery according to any one of (1) to (9),

in which the power storage device supplies electric power to an electronic device connected to the battery.

(14)

The power storage device according to (13), further including:

a power information control device configured to perform transmission and reception of signals with another device via a network,

in which charging and discharging control for the battery is performed on the basis of information received by the power information control device.

(15)

A power system, including:

the battery according to any one of (1) to (9),

in which the power system is supplied with electric power from the battery.

(16)

The power system according to (15),

in which the electric power is supplied from a power generation device or a power network to the battery.

(17)

A battery can, including:

a bottom part of which at least one surface has two or more grooves on a same circumference,

in which a proportion of an inner diameter of the groove to an outer diameter of the bottom part is 44% or more, and

a proportion of a total value of intervals of the grooves in a circumferential direction of the circle to a perimeter of the circle is 2% or more and 24% or less.

### REFERENCE SIGNS LIST

11 battery can
11Bt can bottom (bottom part)
11Gv groove
12, 13 insulator plate
14 battery lid
15 safety valve mechanism
15A disc plate
16 positive temperature coefficient element
17 opening sealing gasket
20 wound electrode body
21 positive electrode
21A positive electrode current collector
21B positive electrode active material layer
22 negative electrode
22A negative electrode current collector
22B negative electrode active material layer
23 separator
24 center pin
25 positive electrode lead
26 negative electrode lead

1. A battery, comprising:
an electrode body; and
a battery can configured to accommodate the electrode body and include a bottom part,
wherein at least one surface of the bottom part has two or more grooves on a same circumference,
a proportion of an inner diameter of the groove to an outer diameter of the bottom part is 44% or more, and
a proportion of a total value of intervals of the grooves in a circumferential direction of the circle to a perimeter of the circle is 2% or more and 24% or less.

2. The battery according to claim 1,
wherein a thickness of the bottom part in a bottom of the groove is 0.020 mm or more and 0.150 mm or less, and
a width of the groove is 0.10 mm or more and 1.00 mm or less.

3. The battery according to claim 1, further comprising:
a safety valve configured to discharge gas in the battery can.

4. The battery according to claim 3,
wherein gas relief pressure of the groove is higher than gas relief pressure of the safety valve.

5. The battery according to claim 1,
wherein the circle is concentric with an outer circumference of the bottom part.

6. The battery according to claim 1,
wherein, of both surfaces of the bottom part, a surface serving as an inside or an outside of the battery can has the two or more grooves on the same circumference.

7. The battery according to claim 1,
wherein a cross-sectional shape of the groove is a substantially trapezoidal shape, a substantially rectangular shape, a substantially triangular shape, a substantially partial circular shape, a substantially partial elliptical shape, or an indefinite shape.

8. The battery according to claim 1,
wherein the electrode body includes a positive electrode and a negative electrode, and
an open circuit voltage in a fully charged state per pair of the positive electrode and the negative electrode is 4.4 V or more and 6.00 V or less.

9. The battery according to claim 1,
wherein the electrode body includes a positive electrode including a positive electrode active material having an average composition indicated by the following Formula (1):
LiᵥNi_{w}M′ₓM″_{y}O_{z} (1)
(here, 0<v<2, w+x+y≤1, 0.8≤w≤1, 0≤x≤0.2, 0≤y≤0.2, 0<z<3, and M′ and M″ are one or more types selected from cobalt (Co), iron (Fe), manganese (Mn), copper (Cu), zinc (Zn), aluminum (Al), chromium (Cr), vanadium (V), titanium (Ti), magnesium (Mg), and zirconium (Zr).)

10. A battery pack, comprising:
the battery according to claim 1; and
a control unit configured to control the battery.

11. An electronic device, comprising:
the battery according to claim 1,
wherein the electronic device is supplied with electric power from the battery.

12. An electric vehicle, comprising:
the battery according to claim 1;
a conversion device configured to be supplied with electric power from the battery and convert the electric power into driving power for the vehicle; and
a control device configured to perform information processing related to vehicle control on the basis of information related to the battery.

13. A power storage device, comprising:
the battery according to claim 1,
wherein the power storage device supplies electric power to an electronic device connected to the battery.

14. The power storage device according to claim 13, further comprising:
a power information control device configured to perform transmission and reception of signals with another device via a network,
wherein charging and discharging control for the battery is performed on the basis of information received by the power information control device.

15. A power system, comprising:
the battery according to claim 1,
wherein the power system is supplied with electric power from the battery.

16. The power system according to claim 15,
wherein the electric power is supplied from a power generation device or a power network to the battery.

17. A battery can, comprising:
a bottom part of which at least one surface has two or more grooves on a same circumference,
wherein a proportion of an inner diameter of the groove to an outer diameter of the bottom part is 44% or more, and
a proportion of a total value of intervals of the grooves in a circumferential direction of the circle to a perimeter of the circle is 2% or more and 24% or less.
